(19) United States
(12) Patent Application Publication
(10) Pub. No.: US 2025/0327437 A1
(43) Pub. Date: Oct. 23, 2025

(54) HYDRAULIC MACHINE PROVIDED WITH A DIRECTION CHANGING DRAWER

(71) Applicant: POCLAIN HYDRAULICS INDUSTRIE, VERBERIE (FR)

(72) Inventors: Loïc BONNARD, VERBERIE (FR); Dominique COSTAZ, VERBERIE (FR)

(21) Appl. No.: 18/862,730

(22) PCT Filed: May 4, 2023
(86) PCT No.: PCT/EP2023/061779

§ 371 Date: Nov. 4, 2024

(30) Foreign Application Priority Data
May 6, 2022 (FR) FR2204306

(51) Int. Cl. F03C 1/40; F03C 1/047; F03C 1/34; F04B 1/063; F04B 1/1071

(52) U.S. Cl. CPC F03C 1/045; F03C 1/0435; F03C 1/0472; F04B 1/063; F04B 1/1071

(57) ABSTRACT

The invention relates to a hydraulic machine (100) comprising:—a distribution cover (2.3);—a distributor (16);—a displacement selection drawer (35) mounted so as to slide between a first position in which the machine is configured to operate with a first displacement and a second position in which the machine is configured to operate with a second displacement different from the first displacement; and—a direction changing drawer (26) mounted so as to slide between a first position in which the machine is configured to exert a torque in a first direction about an axis of rotation (10) and a second position in which the machine is configured to exert a torque in a second direction, the direction changing drawer (26) being mounted so as to slide along an axis (42) at a distance from the axis of rotation (10), the direction changing drawer extending:—in a wall of the distributor (16); or—in a wall of the distribution cover and outside the displacement selection drawer (35).

### FIELD OF THE INVENTION

The invention relates to hydraulic machines.

### PRIOR ART

Known from document FR-3 024 503 is a hydraulic machine comprising a casing, radial pistons, a multilobe cam and a distributor. The machine comprises several submotors. A displacement selection slide valve is mounted sliding between a first position associated with a first displacement and a second position associated with a second displacement. The slide valve position control therefore allows choosing the displacement of the machine. The slide valve is coaxial with the machine and is located in the distributor.

A direction changing slide valve is also provided, which is mounted sliding between first and second positions associated with two pressure configurations. This slide valve is controlled by the pressure difference at the terminals of the machine. It allows, when the configuration of the motor is changed (i.e. when the low pressure and the high pressure are reversed), being certain that the submotor that is overridden or bypassed has no grooves fed at the high pressure. This direction changing slide valve forms in fact a slide valve for selecting the lowest of pressures. This second slide valve extends inside the first, coaxially with the latter. It should be remembered that, in the term “direction changing slide valve,” it is not always the direction of rotation of the hydraulic machine that is changed, but in fact the direction of the torque exerted on the shaft by the hydraulic machine. In fact, different configurations of the slide valve can be imagined where, while the shaft of the machine is turning in the same direction, the machine can operate either as a pump or as a motor (that is for example the case when the hydraulic motor is used in the pump mode to carry out hydrostatic braking).

However, this arrangement makes the manufacture of the machine more complex. It is possible to attempt a remedy by miniaturizing the direction changing slide valve, but this reduction in dimensions makes manufacture more costly and has its limits. In fact, the two slide valves must occupy a certain volume to avoid internal leakage between the lines of the high-pressure and low-pressure circuits. A certain quantity of matter must therefore be associated with them or a certain quantity of materials and great accuracy in the production of the parts in question.

One object of the invention is to facilitate the production of a hydraulic machine comprising such slide valves.

### DISCLOSURE OF THE INVENTION

To this end, a hydraulic machine is provided according to the invention comprising:
A distribution cover,
A distributor,
a displacement selection slide valve mounted sliding between a first position in which the machine is configured to operate with a first displacement and a second position in which the machine is configured to operate with a second displacement different from the first displacement; and
a direction changing slide valves mounted sliding between a first position in which the machine is configured to exert a torque in a first direction around an axis of rotation and a second position in which the machine is configured to exert a torque in a second direction,
   the direction changing slide valve being mounted sliding along an axis distant from the axis of rotation,
   the direction changing slide valve extending:
in a wall of the distributor or
in a wall of the distribution cover and outside the displacement selection slide valve.

Thus, by means of these positions of the direction changing slide valve, the constraints linked to bulk are reduced, which facilitates manufacture. It is then possible to easily produce a high-performance two displacement machine. The positions provided for the direction changing slide valve do not impact performance.

The displacement selection slide valve sees a large flow rate pass, in particular when the machine is in low displacement, given that recirculation of the fluid from the part of the machine that is overridden or bypassed occurs. On the other hand, the direction changing slide valve does not see a flow pass once it is locked in one of the two operating positions (aside from a leakage flow which is minimized by enlarging this slide valve).

The invention allows, if necessary, keeping the displacement selecting slide valve at the center of the distributor so that the circulation of the fluid occurs there as close as possible to the grooves of the high and low pressure lines. But it leads to keeping the direction change slide valve away from the axis of rotation. In the case where the latter extends outside the displacement selection slide valve, this simplifies its manufacture, given that the direction changing slide valve does not see a large flow rate of fluid pass.

Compared to the prior art, the fact of having two separate slide valves allows having slide valves less constrained to compactness.

This technology is applicable to all hydraulic machines, whether they are used in motor mode or in pump mode.

Again, in the term “direction changing slide valve,” it is not always the direction of rotation of the hydraulic machine that is changed, but actually the direction of the torque exerted on the shaft by the machine. In fact there exist different configurations of the slide valve where, when the shaft turns in the same direction, the machine can operate either as a pump or as a motor (this is for example the case when the motor is used in pump mode to carry out hydrostatic braking).

In one embodiment, the displacement selection slide valve extends within the distributor.

Given that the slide valve sees a large flow rate pass when the machine is in low displacement (recirculation of the fluid from the submotor is bypassed); this configuration shortens the trajectories of the oil in order to limit head losses.

It can be provided that the displacement selection slide valve is coaxial with the axis of rotation.

Again, given that the displacement selection slide valve sees a large flow rate pass when the machine is in low displacement (i.e. when one of the submachines is bypassed), this axial configuration shortens as much as possible the trajectories of the oil and limits head losses to a minimum.

It is possible to provide that the direction changing slide valve extends outside the displacement selection slide valve.

It can be provided that the direction changing slide valve is mounted sliding in a direction parallel to the axis of rotation.

It can also be provided that the direction changing slide valve is mounted sliding in a direction that is not parallel to the axis of rotation.

It can be provided that the machine comprises a high-pressure line and a low-pressure line and is configured so that the direction changing slide valve moves under the influence of a pressure in the high-pressure line. The hydraulic machine functions only if a pressure difference is established at its terminals. Depending on the “terminal” where the high pressure occurs, the slide valve places itself in one configuration or in another. The direction changing slide valve places itself in a recess which includes a chamber at each end, each chamber being respectively connected to one or the other of the high-pressure and low-pressure lines.

It can be provided that, the second displacement being less than the first displacement, the second displacement is implemented by a group of pistons or lobes of a cam, the group forming a regular polygon centered on the axis of rotation.

It is also possible to provide that the group forms a figure having axial symmetry and/or central symmetry.

Thus, the appearance of parasitic forces and moments is avoided.

Also provided according to the invention is a subassembly for a hydraulic machine,
the subassembly comprising:
   a distributor,
   a displacement selection slide valve mounted sliding in the distributor between a first position in which the machine is configured to operate with a first displacement and a second position in which the machine is configured to operate with a second displacement different from the first displacement; and
   a direction changing slide valve mounted sliding in the distributor between a first position in which the machine is configured to exert a torque in a first direction around an axis of rotation, and a second position in which the machine is configured to exert a torque in a second direction,

The direction changing slide valve being mounted sliding along an axis distant from the axis of rotation.

For example, the displacement selection slide valve is coaxial with the main axis.

It can be provided that a fluid path from an inlet of the machine to the displacement changing slide valve is shorter than a fluid path from the inlet to the direction changing slide valve.

It can also be provided that,
the cover forming annular grooves,
the distributor forming grooves,
the grooves of the cover and the grooves of the distributor forming a volume having a barycenter,
the displacement selection slide valve is positioned so as to be closer to the barycenter than the direction changing slide valve.

Also provided according to the invention is a device comprising at least one machine according to the invention.

Also provided according to the invention is a method for controlling a hydraulic machine, in which:
a displacement selection slide valve slides between a first position in which the machine is configured to operate with a first displacement and a second position in which the machine is configured to operate with a second displacement different from the first displacement; and
a direction changing slide valve slides between a first position in which the machine is configured to exert a torque in a first direction around an axis of rotation and a second position in which the machine is configured to exert a torque in a second direction around the axis, the direction changing slide valve sliding along an axis distant from the axis of rotation,
   the direction changing slide valve extending:
in a wall of a distributor or
in a wall of a distribution cover and outside the displacement selection slide valve.

Also provided according to the invention is a method of controlling a hydraulic machine, in which:
a displacement selection slide valve slides between a first position in which the machine is configured to operate with a first displacement and a second position in which the machine is configured to operate with a second displacement different from the first displacement, the displacement selection slide valve being controlled by the pressure of a control duct exerting a thrust against a spring; and
a direction changing slide valve slides between a first position in which the machine is configured to exert a torque in a first direction around an axis of rotation and a second position in which the machine is configured to exert a torque in a second direction around the axis, the direction changing slide valve sliding along an axis distant from the axis of rotation,

The direction changing slide valve being moved depend9ing on whether it is the feed or the discharge duct where the high pressure is established in the machine,
the direction changing slide valve extending:
   in a wall of the distributor, or
   in a wall of a distribution cover and outside the displacement selection slide valve.

### DESCRIPTION OF THE FIGURES

We will now present embodiments of the invention by way of non-limiting examples, supporting the drawings in which:

FIG. 1 is an axial section view of a hydraulic machine according to a first embodiment of the invention;

FIGS. 2 to 5 are axial section views showing four operating configurations of the machine of FIG. 1;

FIG. 6 is a transverse section view of the machine;

FIGS. 7 to 10 are views similar to FIGS. 2 to 5 showing a machine according to a second embodiment;

FIG. 11 is an axial section view of the distributor of the machine according to the second embodiment;

FIG. 12 is a view of the direction changing slide valve of this machine; and
FIGS. 13 and 14 illustrate variant embodiments of the ends of the direction changing slide valve.

### 1. FIRST EMBODIMENT

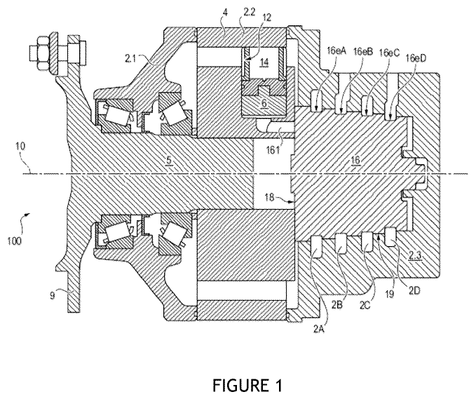

We will describe a first embodiment of the hydraulic machine of the invention with reference to FIGS. 1 to 6.

### 1. Presentation of the Machine

We are mainly presenting the aspects of the machine 100 which relate to the invention. Supplementary details of the machine, known per se, could be obtained from document FR-3 024 503, already mentioned.

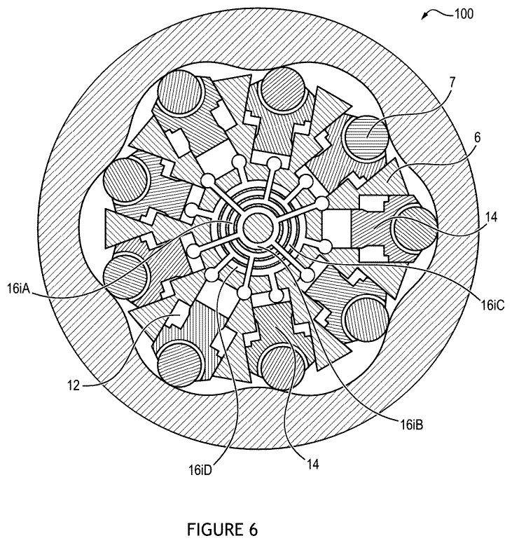

With reference to FIG. 1, the machine 100 comprises a fixed casing, in this case in three parts 2.1, 2.2 and 2.3, succeeding one another along the axis of rotation 10 and assembled for example by screws (not shown in the section plane). It comprises a corrugated or multilobe reaction cam 4 rigidly bonded to the central part 2.2 of the casing, and for example produced within it. The lobes of the cam are visible in FIG. 6.

The machine comprises a cylinder block 6 mounted in rotation relative to the casing and to the cam 4 around the main axis 10 and which has a plurality of cylindrical recesses 12, radial in the present example, able to be fed with fluid under pressure and inside which pistons 14 are mounted sliding. In this case, the cylinder block 6 drives in rotation a shaft 5 which cooperates for this purpose with splines (not shown) of the cylinder block 6. In this example, this shaft carries an output flange 9. Each piston 14 carries a follower 7 by means of which it is supported on the cam and rolls on it.

The machine 100 is of the fixed casing type and has a rotating cylinder block. But the invention also applies to a machine with a rotating casing and a fixed cylinder block. The machine 100 can operate as a motor or as a pump.

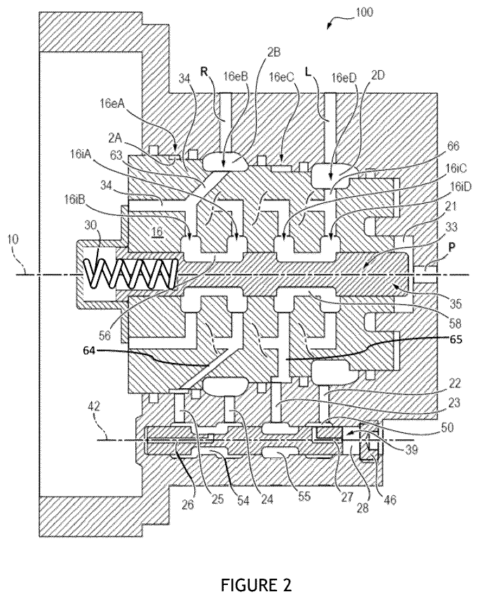

As illustrated in FIG. 2, the machine 100 comprises an internal distributor 16 which is bonded to the casing 2.1, 2.2, 2.3 with respect to rotation around the axis 10. In other words, the distributor 16 and the cam 4 do not turn relative to one another. The distributor 16 is housed inside the rear part 2.3 of the casing, which is also designated here by the term “distribution cover.” This part 2.3 can be a single block by having the shape of a bell as illustrated in FIG. 2, or be closed at its axial end opposite to the cylinder block by an applied plate. This end is considered here to be the rear part of the machine and the flange 9 as its front part.

The distributor 16 has the function of feeding fluid under pressure to the recesses of the pistons when the machine operates in motor mode. The pressure of the pistons on the cam drives, given its multilobed shape, the rotation of the shaft 5 relative to the casing and therefore the driving of the load by the flange 9. In pump mode, the rotation of the shaft drives the rolling of the followers 7 on the cam 4 and the reciprocation of the pistons in their recesses. This causes the discharge of fluid from these recesses and the pressurizing of the high-pressure line via the distributor.

The distributor 16 has a planar outer front face 18 extending in a plane perpendicular to the axis 10 and into which the distribution ducts 34 open. These ducts extend in particular in a direction parallel to the axis 10.

The distributor also has an outer circumferential lateral face 19 which has four annular circular grooves 16eA, 16eB, 16eCet 16eD. The grooves succeed one another in that order in the direction of the axis 10 between the cylinder block, to which the groove 16eA is closest and the rear end, to which the groove 16eD is closest (closest to the rear end).

The distribution cover 2.3 has an inner lateral face 20 which forms a cavity housing the distributor 16 so that the two faces 19 and 20 face one another and are in contact with one another in a male-female assembly. The face 20 of the distribution cover has annular circular main grooves 2A, 2B, 2C and 2D, respectively facing grooves 16eA, 16eB, 16eC and 16eD of the distributor 16.

The grooves 2B and 2D communicate with main feed and discharge ducts, respectively R and L, which are bored into the wall of the distribution cover 2.3. Ducts R and L, and therefore the high-and low-pressure lines, are connected to a hydraulic circuit. In a preferred direction that is selected arbitrarily for the description, the fluid feed in forward movement is accomplished through the duct L and the groove 2D, while discharge occurs through the duct R and the groove 2B. Conversely, in reverse, feed is accomplished through the duct R and the groove 2B while discharge occurs through the duct L and the groove 2D.

Referring to FIGS. 2 to 5, the distributor 16 has a cylindrical central recess 33 with axis 10. Here the recess is of the through type and opens at the two ends of the distributor. Nevertheless, on the cylinder block side there is a plate for retaining the spring.

Annular grooves 16iB, 16iA, 16iC and 16iD are provided in the inner face of this recess, succeeding one another in that order along the front and rear axis.

These grooves are open in their zone directed toward the axis while opening into the central recess 33. They are spaced from one another along the axis so that they are not contiguous. The grooves form with the ducts 34 four respective enclosures for the fluid, which we designate here with the same reference symbols 16iB, 16iA, 16iC and 16iD as the grooves.

Here the machine has two active operating displacements. For this purpose, the ducts 34 form two respective assemblies each comprising a first group of ducts and a second group of ducts. All the ducts 34 allow feeding the piston recesses 12 and are provided in the distributor.

In a first assembly, the first group of ducts 34 is connected to the first enclosure 16iB. Here these ducts 34 are four in number and form the diagonals of a rectangle as illustrated in FIG. 6. The second group of ducts is connected to a second 16iD of the enclosures. Here these ducts are also four in number and form the diagonals of a rectangle identical to the previous one but offset angularly relative to it around the axis. These two groups form a main submachine.

In the second assembly, the first group of ducts is connected to a third of the enclosures 16iA. Here the ducts are two in number and are diametrically opposed on either side of the axis 10. The second group of ducts is connected to the fourth enclosure 16iC. Here the ducts are also two in number and diametrically opposed on either side of the axis 10, this diameter being angularly offset relative to the previous one around the axis. These two groups form a secondary submachine which is sometimes bypassed or overridden so as to make the machine operate with the smallest displacement, namely only with the main submachine.

For example, each submotor or submachine corresponds to a distribution of a certain number of lobes or to a row of pistons of the cylinder block.

The detail of the configuration of all these ducts 34 is not disclosed here, given that it is within the reach of a person skilled in the art to determine this configuration according to the specifications of the machine, particularly the number of cylinders.

With reference to FIG. 2, the machine 100 comprises a displacement selector formed by a slide valve 35 and able to be controlled to give the machine, as desired, a large displacement configuration and a low displacement configuration.

In the large displacement configuration, the first enclosure 16iB and the third enclosure 16iA are connected to one of the main ducts R, L, while the second and fourth enclosures 16iD and 16iC are connected to the other main duct R, L. For example, in the case of the embodiments described later in forward movement, the second and fourth enclosures 16iD and 16iC are connected together and to the main high-pressure duct while the first and third enclosures 16iB and 16iA are connected together and to the other main low-pressure duct.

In the small displacement configuration:
either the first, third and fourth enclosures 16iB, A and C are connected to one of the main ducts (low pressure), while the second enclosure 16iD is connected to the other main duct (high pressure). This corresponds to forward movement;
or the second, third and fourth enclosures 16iD, A and C are connected to one of the main ducts (low pressure), while the first enclosure 16iB is connected to the other main duct (high pressure). This corresponds to reverse.

The first and second groups of distribution ducts 34 thus define respectively the first and second submachines. In large displacement, the two submachines are active because their two corresponding groups of distribution ducts 34 are respectively connected to the feed and to the exhaust. In small displacement, only the first submachine is active, the two groups of distribution ducts 34 of the second assembly, i.e. the second submachine, being connected to the same main duct at the low pressure.

To change the displacement of the motor, the displacement selection slide valve 35 is controlled to cause the machine to pass from one to the other of the configurations. To this end, the slide valve 35 is received coaxially in the central recess 33 of the distributor 16. It is mounted sliding relative to the latter in the axial direction.

Thus the slide valve 35 can be moved between a first position corresponding to the large displacement configuration in which it connects together the first and third enclosures 16iB and A by isolating them from the second and fourth enclosures 16iD and C (the latter themselves also being connected together by the slide valve 35), and a second position which corresponds to the small displacement configuration in which it allows, in conjunction with the slide valve 26, selecting the lowest of the pressures, connecting the three enclosures together while isolating them from the last.

With reference particularly to FIG. 2, the machine 100 also comprises a direction changing slide valve 26. In this embodiment, the slide valve extends in the wall 2.3 of the distribution cover and outside the displacement selection slide valve 35. To this end, the distribution cover comprises a cylindrical housing 39 having an axis 42 parallel to the axis 10 and distant from the latter. The recess 39 is entirely distant from the axis 10 and from the recess 33 of the displacement selection slide valve 35 as well as from the latter. The recess 39, in this example, opens out of the machine on the rear side. It is blocked by a threaded plug 46. The direction changing slide valve 26 is received coaxially in the recess 39 of the distribution cover. It is mounted sliding relative to the latter along the axis 42 between a first position in which the machine is configured to exert a torque in a first direction and a second position in which it is configured to exert a torque in a second direction opposite to the first. The machine is configured so that the direction changing slide valve 26 moves under the influence of a pressure coming from the high-pressure line, as will be seen below.

The two slide valves 35, 26 have grooves on their lateral faces and the direction changing slide valve 26 has internal ducts illustrated in FIG. 2 and arranged to allow the operation presented below. In FIG. 1, the slide valves are not illustrated.

We will now present the operating modes of the machine depending on the displacements.

### 2. In Large Displacement

FIG. 2 corresponds to forward movement for the machine operating as a motor. Therefore the duct L corresponds to the feed and receives a high pressure communicated to the groove 2D of the distribution cover. The groove 2D being axisymmetrical (it goes completely around the distributor 16), the high pressure is also established in a duct 22 which extends from the groove 2D to a groove 50 of the recess 39. The fluid under pressure then passes through an internal duct 27 of the slide valve 26 connecting its lateral wall facing the groove 50 and its right axial end face oriented rearward. Hence regardless of the initial position of this slide valve 26, the fluid under pressure passing in the duct 27 exerts a thrust in the chamber 28 extending in the recess 39 between this face and the plug 46 so as to place this slide valve in the forward movement configuration of FIG. 2, namely its forwardmost position, here the one farthest to the left.

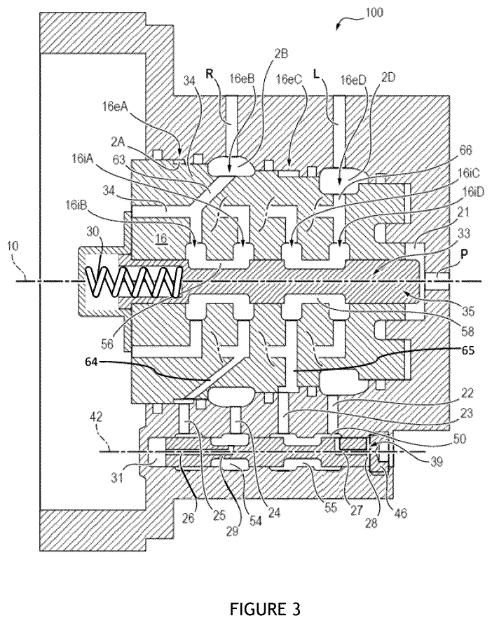

FIG. 3 corresponds to reverse for this motor. This means that the duct R corresponds to the feed and receives a high pressure which is communicated to the groove 2B. This groove being axisymmetrical, the high pressure is also established in a duct 24 which extends in the distribution cover, from the groove 2B to a groove 54 of the slide valve 26. The fluid under pressure then passes through an inner duct 29 of the slide valve 26 connecting its groove 54 and its left axial end face oriented toward the cylinder block 6. From then on, regardless of the initial position of the slide valve 26, the fluid under pressure passing through the duct 29 exerts a thrust in a chamber 31 extending in the recess 39 between this face and the bottom of the recess so as to place this slide valve in the reverse configuration of FIG. 3, namely its rearmost position, in abutment against the plug 46.

As illustrated in FIG. 2, it is appropriate to note that in the distributor 16:
the outer groove 16eA is permanently in communication through a duct 64 with the inner groove 16iA,
the outer groove 16eB is permanently in communication through a duct 63 with the inner groove 16iB,
the outer groove 16eC is permanently in communication with the inner groove 16iC through a duct65, and
the outer groove 16eD is permanently in communication through a duct 66 with the inner groove 16iD.

These inner ducts are shown in the section plane of FIG. 2, but can in fact be in different planes from each other.

The displacement selection slide valve 35 is controlled by a hydraulic control duct P opening into a chamber 21 located at the end of the recess 33. The control duct P is connected to a pilot line where a control pressure will be applied or not depending on the desired displacement. By default, this slide valve is in the configuration of FIGS. 2 and 3, where no pressure is exerted by the control duct P in the chamber 21. A spring 30 exerting a return force on the slide valve, this is then biased in the direction of the pilot line. This configuration allows the connection of the groove 16iB with the groove 16iA via a first annular lateral groove 56 of the slide valve 35 and that of the groove 16iC with the groove 16iD through a second annular lateral groove 58 of the slide valve.

Therefore, in forward movement or in reverse, there are two inner grooves connected to the high pressure and two inner grooves connected to the low pressure.

### a) In Forward Movement

With reference to FIG. 2, in forward movement, the high pressure arrives through the feed duct L which arrives in the groove 2D connected to the inner groove 16iD through the duct 66. Through the displacement selection slide valve 35, the inner groove 16iD is in fluid relation with the inner groove 16iC. These two grooves are therefore at the high pressure. They correspond to the feeding of the two submotors.

The discharge duct R is connected to the groove 2B which is connected to the groove 16iB by the duct 63. Through the displacement selection slide valve 35, the inner groove 16iB is in fluid relation with the inner groove 16iA. These two grooves are at the low pressure and correspond to the discharge of the two active submotors.

The motor formed by the machine thus operates with full displacement with each of the two submotors fed with the high pressure and discharging at the low pressure.

### b) In Reverse

With reference to FIG. 3, in reverse, the high pressure arrives through the feed duct R which arrives in the groove 2B connected to the inner groove 16iB through the duct 63. Through the displacement selection slide valve 35, the inner groove 16iB is in fluid relation with the inner groove 16iA: these two grooves are therefore at the high pressure.

The discharge duct L is connected to the groove 2D which is connected to the groove 16iD through a duct 66. Through the slide valve 35, the inner groove 16iD is in fluid relation with the inner groove 16iC: these two grooves are at low pressure and correspond to the discharge of a submotor.

There too, the motor therefore operates at full displacement with each of the two submotors fed at the high pressure and discharging at the low pressure.

### 3. In Small Displacement

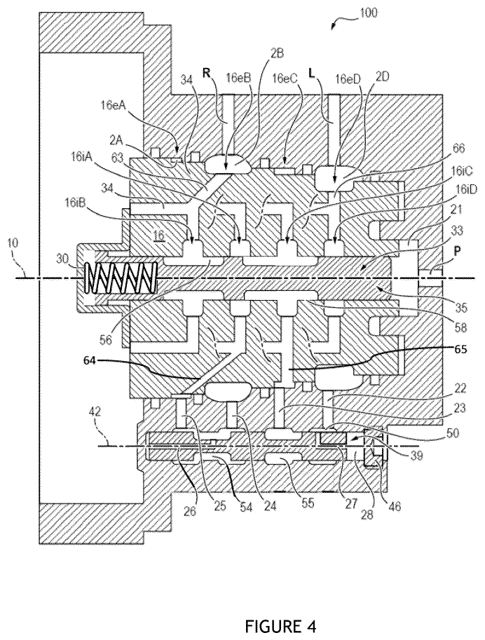

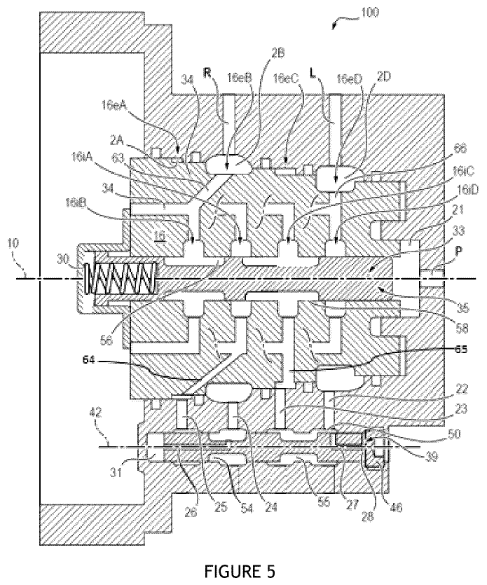

When a pressure is applied by the control duct P in the chamber 21, the displacement selection slide valve 35 is pressed to oppose the force exerted by the spring 30. It then places itself into a low displacement configuration, to the left, where a submotor is deactivated as illustrated in FIGS. 4 and 5. The position of the slide valve 35 therefore isolates each of the inner grooves 16iB and 16iD from the other grooves. The inner grooves 16iA and 16iC are placed into communication with one another.

### a) In Forward Movement

In forward movement, with reference to FIG. 4, the fluid under pressure arrives through the duct L, which corresponds to the feed. High pressure is then established in the groove 2D and also in the inner groove 16iD by the fluid communication achieved by the duct 66. The displacement selection slide valve 35 is arranged in this configuration so as to isolate the inner groove 16iD from the other inner grooves. High pressure is also established in the duct 22 by the groove 2D and, as previously described, it is also established in the duct 27, thus placing the chamber 28 under high pressure so as to place the direction changing slide valve 26 in the configuration of FIG. 4, to the left. This slide valve in this configuration does not allow fluid relation of the high pressure of duct 22 with another enclosure (in particular no fluid relation with the duct 23). Therefore only one enclosure is subjected to the high pressure. This corresponds to the feed of a single submotor.

The discharge that occurs through the duct R is at the low pressure. The groove 2B is therefore at the low pressure and also the inner groove 16iB due to the existence of the duct 63. Taking into account the configuration of the displacement selection slide valve 35, the inner groove 16iB seems to be isolated from the other enclosures. Nevertheless, through the groove 2B, the duct 24 is itself connected with the low pressure, and taking into account the position of the direction changing slide valve 26, the ducts 24 and 25 are in relation through the groove 54. The duct 25, for its part, is in relation with the duct 64, which allows setting the inner groove 16iA at the low pressure. Yet it is placed in relation with the inner groove 16iC by the position of the displacement selection slide valve 35.

Summarizing, in the configuration of FIG. 4, the enclosure connected to the groove 2D is at the high pressure and all the other enclosures connected to the grooves 2B, 2A and 2C are at the low pressure. One of the sub-motors is overridden or bypassed: it is not put under pressure. Its intake and discharge are at the low pressure.

### b) In Reverse

In reverse, with reference to FIG. 5, the fluid under pressure arrives through the duct R, which corresponds to the feed. High pressure is then established in the groove 2B. It is also established in the inner groove 16iB by the fluid communication achieved by the duct 63. The displacement selection slide valve 35 is arranged in this configuration so as to isolate the inner groove 16iB from the others. High pressure is also established in the duct 24 by the groove 2B. AS previously described, this high pressure is also established in the duct 29 of the slide valve 26, thus placing the left chamber 31 under the high pressure so as to place the slide valve to the right, in the configuration of FIG. 5 closest to the plug 46. This slide valve, in this configuration, does not allow fluid relation of the high pressure of the duct 24 to another enclosure (in particular no relation with the duct 25). Again, there is therefore only one enclosure subjected to the high pressure. This corresponds to the feed of a single submotor.

Discharge, which occurs through the duct L, is at the low pressure. The groove 2D is therefore at the low pressure and also the inner groove 16iD due to the existence of the duct 66. Taking into account the configuration of the slide valve 35, the inner groove 16iD seems isolated from the other enclosures. Nevertheless, through groove 2D, the duct 22 is itself in connection with the low pressure and, taking into account the position of the direction changing slide valve 26, the ducts 22 and 23 are in relation through the groove 50. The duct 23, for its part, is in relation with the duct 65, which allows setting the inner groove 16iC at the low pressure. Yet the latter is placed in relation with the inner groove 16iA by the position of the displacement selection slide valve 35.

Summarizing, in the configuration of FIG. 5, the enclosure connected to the groove 2B is at the high pressure and all the other enclosures connected to the grooves 2D, 2C and 2A are at the low pressure. There too, one of the submotors is overridden or bypassed: it is not pressurized. Its intake and its discharge are at the low pressure.

The submotor which is sometimes deactivated corresponds to the grooves 2A and 2C. The submotor which is never deactivated corresponds to the enclosures connected to the grooves 2B and 2D.

When a motor is bypassed, the pistons 14 associated with it continue to follow the profile of the cam 4 (except in the case where the pistons are retracted by free-wheel springs, or free-wheeling). This continues to generate a recirculation of fluid in the bypassed submotor. This recirculation occurs in our case by means of the displacement selection slide valve 35 between the enclosures 2A and 2C.

In the machine of this embodiment, it is observed that a fluid path from an inlet of the machine to the displacement changing slide valve 35 is shorter than a fluid path from the inlet to the direction changing slide valve 26. In this example, this is obtained by the fact that the displacement selection slide valve 35 extends in the distributor while being coaxial with the axis of rotation, while the direction changing slide valve 26 is located in a wall of the distribution cover and outside the displacement selection slide valve 35.

But this arrangement can also be obtained, considering that the grooves 2A, 2B, 2C and 2D of the cover and the grooves of the distributor 16eA, 16eB, 16eC and 16eD form a volume having a barycenter, due to the fact that the displacement selection slide valve 35 is positioned so as to be closer to this barycenter than the direction changing slide valve 26. With reference to the embodiments described in FIGS. 1 to 5 and 11, the barycenter is conflated with the axis 10.

### II. SECOND EMBODIMENT

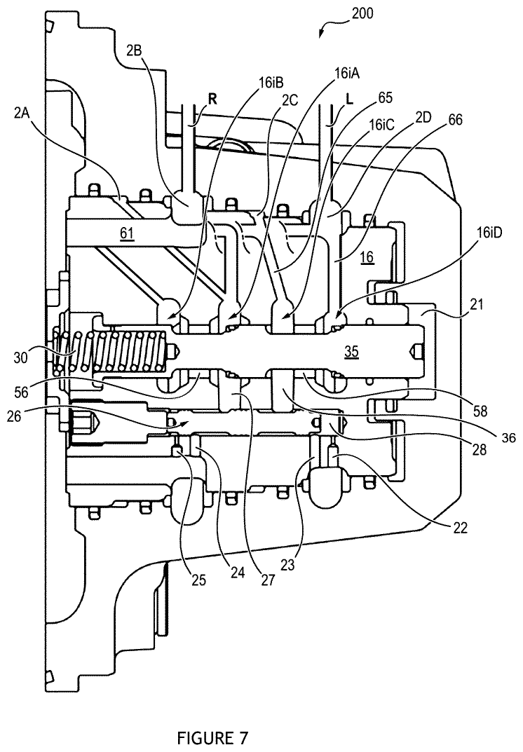

We will now describe a second embodiment with reference to FIGS. 7 to 12. Certain common features with the first embodiment will not be presented again.

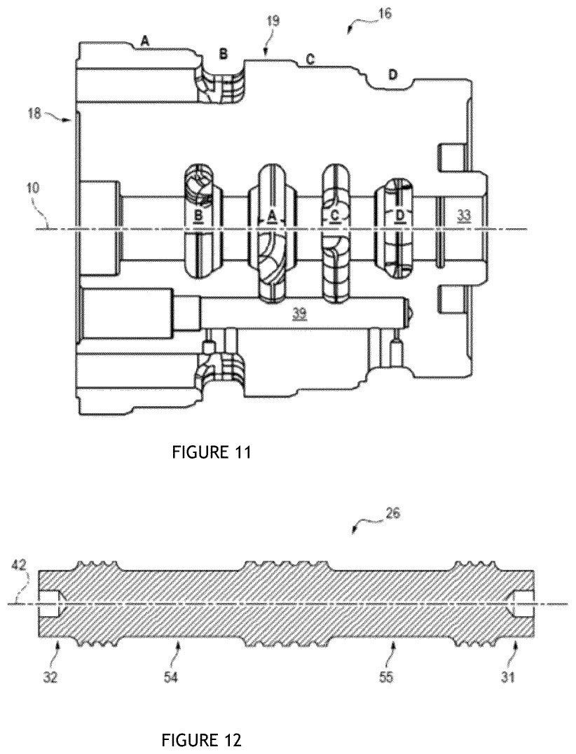

The principal difference between this machine 200 and that of the first embodiment is that this time the direction changing slide valve 26 and its recess 39 extend in a wall of the distributor 16. This appears in FIGS. 7 and 11, the latter showing the distributor alone. However, as in the first embodiment, this recess and the slide valve 26 are completely outside the displacement selection slide valve 35 and at a distance from it.

The structure of the machine is generally the same, and its operation as well, the configuration of certain ducts being modified to take into account the position of the slide valve 26 in the distributor 16.

This embodiment in particular allows space saving in the cover.

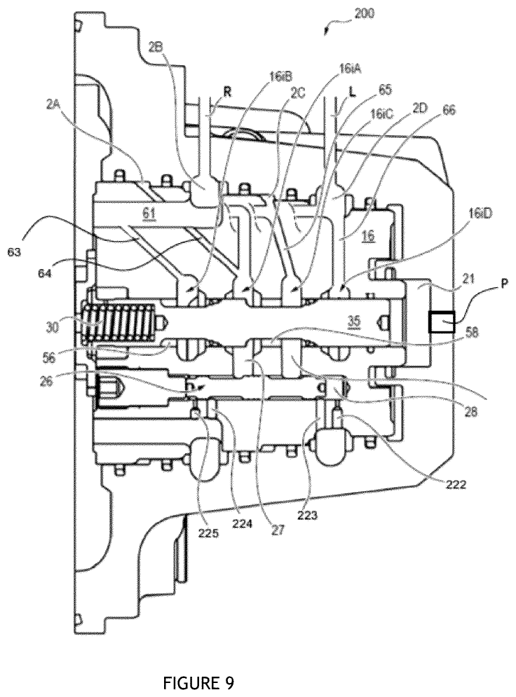

FIG. 7 corresponds to forward movement for this motor. This means that the duct L corresponds to the feed and receives the high pressure, which is communicated to the groove 2D. The groove 2D being axisymmetrical, the high pressure is also established in the duct 222 which communicates with it. Regardless of the initial position of the direction changing slide valve 26, the fluid under pressure arrives in the chamber 28 due to the end segment of the slide valve 26, which has a reduced diameter relative to the adjacent segment where it faces this duct 222. The fluid exerts an axial thrust on this segment and places this slide valve in the configuration of FIG. 7, to the left, closest to the cylinder block, which is also the position that the slide valve takes in the forward motion configuration of FIG. 9.

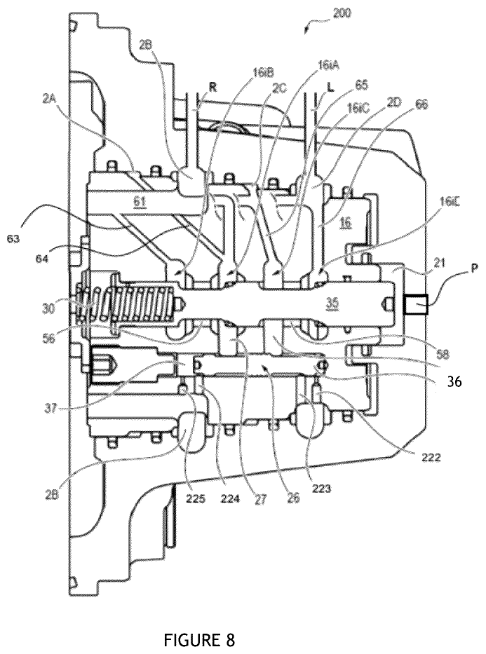

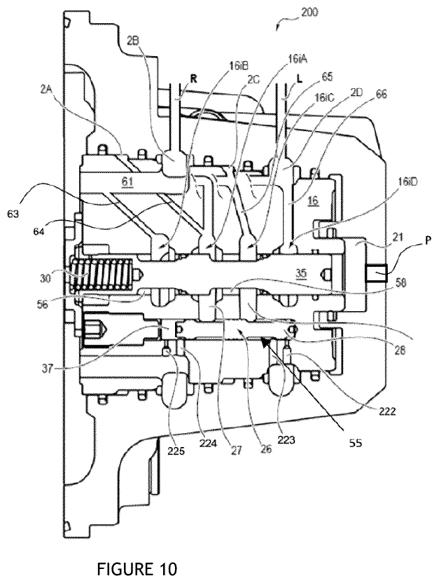

FIG. 8 corresponds to reverse for this motor. This means that the duct R corresponds to the feed and receives the high pressure communicated to the groove 2B. This being axisymmetrical, the high pressure is also established in the duct 224 which communicates with the groove 2B. There too regardless of the initial position of the direction changing slide valve 26, the fluid under pressure arrives in the chamber 37 via the duct 225 facing the left axial end segment of the slide valve 26 which has a reduced diameter relative to the adjacent segment. The fluid exerts an axial thrust on this segment and places this slide valve in the configuration of FIG. 8, which is also the configuration of FIG. 10, thus on the right.

With reference to FIG. 7, it is appropriate to note that:
the groove 2A is permanently in communication (through the duct 64) with the inner groove 16iA,
the groove 2B is permanently in communication (through the duct 63) with the groove16iB,
the groove 2C is permanently in communication with the groove 16iC (through the duct 65) and
the groove 2D is permanently in communication (through the duct 66) with the groove 16iD.

These inner ducts are shown in the section plane, but can be in different respective planes.

The displacement selection slide valve 35 is controlled by the hydraulic control duct P. By default, this slide valve is in the configuration of FIGS. 7 and 8 where no pressure is exerted by the control duct P in the chamber 21. The spring 30 exerting a return force on the slide valve 35, it is then pressed in the direction of the control duct. This configuration allows the connection of the groove 16iB with the groove 16iA and also the connection of the groove 16iC with the groove 16iD. Therefore, in forward motion or in reverse, there are two inner grooves connected to the high pressure and two inner grooves connected to the low pressure.

### 4. In Large Displacement

### a) In Forward Movement

With reference to FIG. 7, in forward movement, the high pressure arrives through the feed duct L into the groove 2D connected to the inner groove 16iD through the duct 66. Through the groove 58 of the slide valve 35, the inner groove 16iD is in fluid relation with the inner groove 16iC. They are therefore at the high pressure and correspond to the feed of the two submotors.

The discharge duct R is connected to the groove 2B, which is connected to the groove 16iB through the duct 63. Through the groove 56 of the displacement selection slide valve, the inner groove 16iB is in fluid relation with the inner groove 16iA: these two grooves are at the low pressure and correspond to the discharge of the two submotors.

The motor therefore operates at full displacement with each of the two submotors fed with the high pressure and discharging at the low pressure.

### b) In Reverse

With reference to FIG. 8, in reverse, the high pressure arrives through the feed duct R in the groove 2B connected to the inner groove 16iB through the duct 63. Through the groove 56; the inner groove 16iB is in fluid relation with the inner groove 16iA: these two groves are therefore at high pressure.

The discharge duct L is connected to the groove 2D which is connected with the groove 16iD through the duct 66. Through the groove 58, the inner groove 16iD is in fluid relation with the inner groove 16iC: these two grooves are at the low pressure and correspond to the discharge of the two submotors.

There too, the motor therefore operates at full displacement with the two submotors fed at high pressure and discharging at the low pressure.

### 5. In Low Displacement

In low displacement, when a pressure is applied through the control duct P in the chamber 21, the displacement selection slide valve 35 is biased against the force exerted by the spring 30. It then places itself to the left in a low displacement configuration when one submotor is deactivated, as in FIGS. 9 and 10. It is moved in the direction of the cylinder block and compresses the spring. The position of this slide valve 35 therefore isolates the inner groove 16iB from the other grooves and also isolates the inner groove 16iD from the other grooves while the inner grooves 16iA and 16iC are placed in communication with one another.

### a) In Forward Movement

FIG. 9 corresponds to forward movement. This means that the duct L corresponds to feed and receives a high pressure which is communicated to the groove 2D. The high pressure is also established in the ducts 222 and 223 which communicate with the groove 2D. And regardless of the initial position of the direction changing slide valve 26, the fluid under pressure arrives in the right chamber 28 through the duct 222 with a reduced diameter, due to the end segment 31 with a reduced diameter of the slide valve. The fluid exerts an axial thrust on this segment 31 and places the slide value 26 in the configuration of FIG. 9, to the left. This slide valve then does not allow fluid relation of the high pressure of the duct 222 (Or 223) with another enclosure.

The high pressure in the groove 2D is also established in the inner groove 16iD by the fluid communication achieved by the duct 66. The displacement selection slide valve 35 is arranged in this configuration so as to isolate the inner groove 16iD from the other inner grooves. A single enclosure associated with the grooves, namely the enclosure of the groove 2D, is therefore subjected to a high pressure. This corresponds to the feed of a single submotor.

The discharge through the duct R is at the low pressure. The groove 2B is therefore at the low pressure and also the inner groove 16iB due to the existence of the duct 63 (see FIG. 7). Taking into account the configuration of the displacement selection slide valve 35, the inner groove 16iB seems to be isolated from the other enclosures. Nevertheless, through the groove 2B, the duct 224 is at the low pressure. Taking into account the position of the direction changing slide valve 26 and of its groove 54, the ducts 224 and 27 are placed in relation. As the duct 27 is in relation with the inner groove 16iA, it also puts itself at the low pressure. Yet the inner groove 16iA is placed in relation with the inner groove 16iC by the position of the displacement selection slide valve 35.

Summarizing, in the configuration of FIG. 9, the enclosure connected to the groove D is at the high pressure, and all the other enclosures B, A and C are at the low pressure. One submotor is bypassed and is not pressurized: its intake and its discharge are at the low pressure.

### b) In Reverse

FIG. 10 corresponds to reverse for low displacement. This means that the duct R corresponds to the feed and receives a high pressure communicated to the groove 2B. The high pressure is also established in the duct 225 which communicates with the groove B. There too, regardless of the initial position of the slide valve 26, the fluid under pressure arrives in the left chamber 37, due to the end segment 32 with a reduced diameter of the slide valve, through the duct 224 with a reduced diameter. The fluid exerts an axial thrust on this segment and places this slide valve 26 in the configuration of FIG. 10, in end-of-travel abutment in the rearward direction, to the right.

The high pressure in the groove 2B is also established in the inner groove 16iB by the fluid communication achieved by the duct 63. The displacement selection slide valve 35 is arranged in this configuration so as to isolate the inner groove 16iB from the other inner grooves. The high pressure is also established in the duct 224 by the groove B and, as described previously, this high pressure is also established via the reduction in diameter 32 in the chamber 37 so as to place the direction changing slide valve 26 in the configuration of FIG. 10. This slide valve in this configuration does not allow fluid relation of the high pressure of the duct 224 or 225 with another.

A single enclosure is therefore subjected to the high pressure. This corresponds to the feed of a submotor.

The discharge which occurs through the duct L is at the low pressure. The groove 2D is therefore at the low pressure and also the inner groove 16iD due to the existence of the duct 66 (see FIG. 7). Taking into account the configuration of the displacement selection slide valve 35, the inner groove 16iD seems to be isolated from all the other enclosures. Nevertheless, through the groove 2D, the duct 222 is itself also connected with the low pressure. Taking into account the position of the direction changing slide valve 26, the ducts 223 and 36 are in relation through the segment with a reduced diameter 55 of the slide valve 26. The duct 36 allows the inner groove 16iC to be set at the low pressure. Yet this is placed in relation wih the inner groove 16iA by the position of the displacement selection slide valve 35.

Summarizing, in the configuration of FIG. 10, the enclosure connected to the groove 2B is at the high pressure and all the other enclosures associated respectively with the grooves 2D, 2C and 2A are at the low pressure. There too, one submotor is bypassed: its intake and its discharge are at the low pressure.

In this embodiment, a subassembly for a hydraulic machine is thus identified which comprises the distributor 16, the displacement selection slide valve 35 and the direction changing slide valve 26.

The reduced diameter of the ducts 222, 225 serves to damp the movement of the direction changing slide valve 26 or a shuttle valve. In fact, they form jets, or restrictions, which have the effect of limiting the flow rate and preventing too rapid a change of the slide valve from one position to another. In the figures, it is seen that the jets are achieved by a reduction in the diameter of the bore 222, 224. Alternatively it is possible to imagine that this is accomplished for example by a perforated stopper which could be introduced by force into the duct with a constant cross section.

It is possible to apply numerous modifications to the invention without departing from its scope.

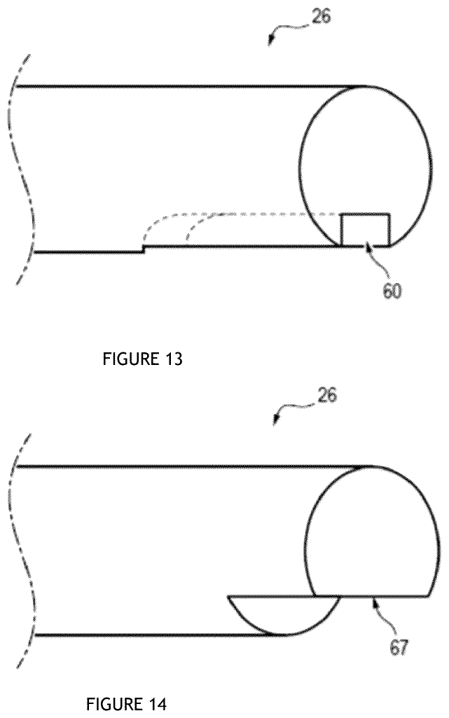

In the second embodiment, the segments with reduced diameter of the direction changing slide valve 26 are accomplished by annular grooves. In the variant of FIG. 13, it is possible to provide the same function with a slot 60. In the variant of FIG. 14, this function is provided by a flat 62. In the first embodiment, this function is provided by internal ducts of the direction changing slide valve 26.

As illustrated in FIG. 12, the direction changing slide valve is symmetrical. This facilitates production and avoids problems in assembly of the hydraulic machine.

1. A hydraulic machine comprising:
a distribution cover,
a distributor,
a displacement selection slide valve mounted sliding between a first position in which the machine is configured to operate with a first displacement and a second position in which the machine is configured to operate with a second displacement different from the first displacement; and
a direction changing slide valve mounted sliding between a first position in which the machine is configured to exert a torque in a first direction around an axis of rotation and a second position in which the machine is configured to exert a torque in a second direction,
the direction changing slide valve being mounted sliding along an axis distant from the axis of rotation,
the direction changing slide valve extending:
in a wall of the distributor or
in a wall of the distribution cover and outside the displacement selection slide valve.

2. The machine according to the preceding claim, wherein the displacement selection slide valve extends within the distributor.

3. The machine according to claim 1, wherein the displacement selection slide valve is coaxial with the axis of rotation.

4. The machine according to claim 1, wherein the direction changing slide valve extends outside of the displacement selection slide valve.

5. The machine according to claim 1, wherein the direction changing slide valve is mounted sliding in a direction parallel to the axis of rotation.

6. The machine according to claim 1, wherein the direction changing slide valve is mounted sliding in a direction that is not parallel to the axis of rotation.

7. The machine according to claim 1, which comprises a high-pressure line and a low-pressure line and is configured so that the direction changing slide valve moves under an influence of a pressure in the high-pressure line.

8. The machine according to claim 1 wherein, the second displacement being less than the first displacement, the second displacement is implemented by a group of pistons or a group of lobes of a cam, the group forming a regular polygon centered on the axis of rotation.

9. The machine according to claim 1, wherein a fluid path from an inlet of the machine to the displacement changing slide valve is shorter than a fluid path from the inlet to the direction changing slide valve.

10. The machine according to claim 1 wherein,
the cover forming annular grooves,
the distributor forming grooves,
the grooves of the cover and the grooves of the distributor forming a volume having a barycenter,
the displacement selecting slide valve is positioned closer to the barycenter than the direction changing slide valve.

11. A device comprising at least one machine according to claim 1.

12. A subassembly for a hydraulic machine,
the subassembly comprising:
a distributor,
a displacement selection slide valve mounted sliding in the distributor between a first position wherein the machine is configured to operate with a first displacement and a second position wherein the machine is configured to operate with a second displacement different from the first displacement; and
a direction changing slide valve mounted sliding in the distributor between a first position wherein the machine is configured to exert a torque in a first direction around an axis of rotation and a second position wherein the machine is configured to exert a torque in a different direction,
the direction changing slide valve being mounted sliding along an axis distant from the axis of rotation.

13. A method for controlling a hydraulic machine, wherein:
a displacement selection slide valve slides between a first position wherein the machine is configured to operate with a first displacement and a second position wherein the machine is configured to operate with a second displacement different from the first displacement; and
a direction changing slide valve slides between a first position wherein the machine is configured to exert a torque in a first direction around an axis of rotation and a second position wherein the machine is configured to exert a torque in a second direction around the axis, the direction changing slide valve sliding along an axis distant from the axis of rotation,
the direction changing slide valve extending:
in a wall of a distributor, or
in a wall of a distribution cover and outside the displacement selection slide valve.
